(19) United States
(12) Patent Application Publication
(10) Pub. No.: US 2018/0082257 A1
(43) Pub. Date: Mar. 22, 2018

(54) Sports Computer Application

(71) Applicant: Assad Rashwan, Long Beach, CA (US)

(72) Inventor: Assad Rashwan, Long Beach, CA (US)

(21) Appl. No.: 15/710,388

(22) Filed: Sep. 20, 2017

Related U.S. Application Data
(60) Provisional application No. 62/396,920, filed on Sep. 20, 2016.

(51) Int. Cl. G06Q 10/10; H04L 12/58; H04L 29/08; G06Q 50/00

(52) U.S. Cl. CPC G06Q 10/1053; G06Q 50/01; H04L 67/306; H04L 51/04

(57) ABSTRACT

A sports computer application for connecting athletes and other users with desired sports clubs and organizations is provided. The sports computer application comprises an electronic device and a software program downloaded on the electronic device. Upon launching the software program, the software program allows the athlete to download data into the electronic device, the downloaded data related to sports data and statistics.

### CLAIM OF PRIORITY

This patent application claims priority under 35 USC 119 (e) (1) from U.S. Provisional Patent Application Ser. No. 62/396,920 filed Sep. 20, 2016, of common inventorship herewith entitled, “Sports App,” which is incorporated herein by reference as though the same were set forth in its entirety.

### FIELD OF THE INVENTION

The present invention pertains to the field of computer applications, and more specifically to the field of computer application providing a technologically advanced means of connecting talented athletes with desired sports clubs and organizations specifically for use by the athletes seeking opportunities and the clubs that are searching for the next athletic superstar.

### BACKGROUND OF THE INVENTION

Once a young athlete realizes his or her talent and potential, the goal of being recruited to play for a reputable college team as well as professional organizations is undertaken in earnest. Many believe that recruiting starts in an athlete's junior or senior year of high school; however, the process can begin as early as eighth grade, sometimes earlier.

Because the recruiting process is complicated and time consuming, the earlier one gets started, the more successful the results. However, getting recruited is no easy task, not even for the country's most talented athletes. While an athlete's talent, GPA, and ACT/SAT scores are important, if a college coach has never heard of the athlete or seen them play, they are not getting recruited. And unfortunately, high school coaches often do not have the time, contacts, or resources to get an athlete recruited. Ultimately, it is the responsibility of the athletes the get themselves noticed. Making sure they maximize their performance and exposure in the media as well as with a dynamite portfolio, including a highlight film delivered to the hands of the decision maker, increases the prospective athlete's chances of success.

The prior art has put forth several designs for sports computer software. Among these are:

US Patent Application No. 2015/0081402 to Seth Blumberg provides a system, method, and apparatus for computerized management of a method of corporate, business or sports management by a remote party comprising relating a current database of an entity. Data of a player together with a historical database related to that player and decisions can be transmitted. This is communicated between a central database processing resource and at least one remote party. A remote party is permitted to access the database and access designated data from the database, and input and output data. Voting and other management of the player, team, or business is possible in substantially real time or near real time by the remote party. A remote user can vote on financial compensation for a player, a coach or a team and/or for a bonus for a player, team or game. Similarly hiring and firing decisions can be made. Shareholders, fans or customers of an entertainment business such as sports can be more interactively involved in all aspects of management and ownership duties and thus be more thoroughly entertained.

US Patent Application No. 2008/0010343 to Escaffi et al provides a method of developing an internet sports social network web page with advertising, having the steps of accumulating a community based database of athlete or activities information, determining an advertising section profile for the web page based on the accumulated database, and preparing the network web page based on the database accumulated.

US Patent Application No. 2011/0066664 to Goldman et al provides a sports management system having a platform and social network for those associated with youth and other sports to simplify common tasks, unify related participants, and enhance the activities surrounding playing sports. The system brings together players, parents, and coaches into an integrated experience centered on the information each is interested in. The system is not tied to any one sport, but rather can unify information from multiple sports so families that have multiple children playing, for example, soccer, football, basketball, and baseball can follow information about their players and teams throughout the year. Thus, the sports management system provides a one-stop location for all parties related to youth and other sports to gather and share information.

US Patent Application No 2014/0067098 to Regan et al provides a system of collecting and displaying statistical performance data of American football or rugby football tactical plays includes optional ball tracking sensors, data loggers worn by each player that include accelerometers and location sensors that provide data on duration of play acceleration, speed, direction of movement, possession of ball, and force of impacts. A processor collects and analyzes the data for each tactical play to determine the initial line of scrimmage for each play, the end of each play, for each player one or more of duration of play, acceleration, speed, direction of movement, possession of ball, force of impacts, and normalizing all the statistics so that all tactical plays and all individual player performances can be compared from the same start point. Display means graphically displays the statistics and combine the graphics with video images of the play and players.

None of these prior art references describe the present invention.

### SUMMARY OF THE INVENTION

It is an object of the present invention to provide a technologically advanced means of connecting talented athletes with desired sports clubs and organizations specifically for use by the athletes seeking opportunities and the clubs that are searching for the next athletic superstar.

The present invention is a sports computer application for connecting athletes and other users with desired sports clubs and organizations. The sports computer application comprises an electronic device and a software program downloaded on the electronic device. Upon launching the software program, the software program allows the athlete to download data into the electronic device, the downloaded data related to sports data and statistics.

In addition, the present invention includes a method for connecting athletes and other users with desired sports clubs and organizations. The method comprises providing an electronic device, downloading a software program on the electronic device, launching the software program, allowing the athlete to download data into the electronic device and relating the downloaded data specifically to sports data and statistics.

The present invention further includes a sports computer application for connecting athletes and other users with desired sports clubs and organizations. The sports computer application comprises an electronic device and a software program downloaded on the electronic device. Upon launching the software program, the software program allows the athlete to download data into the electronic device, the downloaded data related to sports data and statistics. The software program creates a profile with a username and password. The software program includes menu prompts allowing creation of a profile/portfolio.

### BRIEF DESCRIPTION OF THE DRAWINGS

FIG. 1 is a perspective view illustrating a sports computer application, constructed in accordance with the present invention.

FIG. 2 is another perspective view illustrating the sports computer application, constructed in accordance with the present invention.

FIG. 3 is still another perspective view illustrating the sports computer application, constructed in accordance with the present invention.

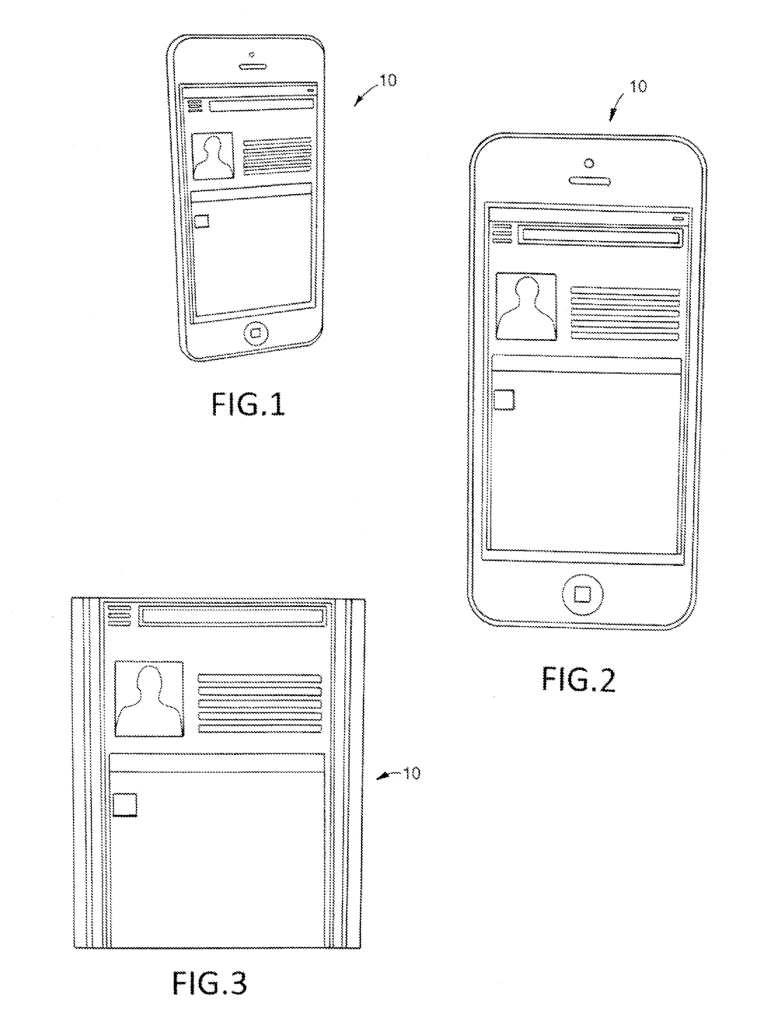

### DETAILED DESCRIPTION OF THE INVENTION

The present invention, hereinafter referred to as a Sports Computer Application, indicated generally at 10 provides a technologically advanced means of connecting talented athletes with desired sports dubs and organizations. Designed specifically for use by the athletes seeking opportunities and the clubs that are searching for the next athletic superstar, the Sports Computer Application is a software application allowing both parties to eliminate costly “middlemen,” such as recruitment brokers, by directly linking together. The Sports Computer Application will be available in a digital download store, for a nominal fee, and would be compatible with iPhones, iPads, and other smartphone and tablet computer platforms. Additionally, the Sports Computer Application can sync with Google Calendar, iCloud, and Exchange.

Once the Sports Computer Application 10 of the present application is downloaded to a chosen device, athlete users create a profile with the requisite username and password. Following easy menu prompts, the user is able to create his or her profile/portfolio; simply navigated tabs are provided for inputting and/or uploading a resume, photo, the all-important highlight video, medical reports, and other pertinent information including contact info, desired playing position, left or right status, and similar.

The information profile created with the Sports Computer Application 10 of the present application is made available for view and access by the sporting clubs that utilize this service. Additionally, athlete users are able to search for clubs and organizations currently seeking players, and apply directly to them via the Sports Computer Application 10. The clubs and organizations are thus able to advertise for needed players and, as mentioned above, browse through posted profiles to discover new talent they may wish to sign. On strategy is that the Sports Computer Application 10 for Sponsoring/Signing New Ahletes and Talents will initially focus on the three (3) most popular global sports currently: soccer, basketball, and (American) football, with the potential to expand to other sports once the app and service are established.

As envisioned, the Sports Computer Application 10 of the present invention offers a unique approach to sports recruitment and provides a number of significant benefits and advantages to both aspiring athletes and clubs. Eliminating the need to depend on brokers, which can be prohibitively expensive, the Sports Computer Application 10 for Sponsoring/Signing New Athletes and Talents allows for instant, direct contact between talented athletes and the teams seeking them. By creating a comprehensive profile that highlights one's prowess and is augmented with both written and video evidence, young athletes possess an easy tool that helps them get noticed, and eventually offered a position with a club of their choosing. At the same time, sporting clubs and organizations appreciate that their recruitment process has become essentially effortless. Coaches and scouts are able to save time, money, and hassle by direct connection to talented players all over the country, and the world, as the Sports Computer Application 10 greatly assists in discovering the next new player that will take the sports world by storm. Fully developed, the Sports Computer Application 10 is certain to make many dreams come true.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A sports computer application for connecting athletes and other users with desired sports clubs and organizations, the sports computer application comprising:
an electronic device; and
a software program downloaded on the electronic device;
wherein upon launching the software program, the software program allows the athlete to download data into the electronic device, the downloaded data related to sports data and statistics.

2. The sports computer application of claim 1 wherein the electronic device is selected from the group consisting of a smartphone, a tablet, a laptop and a computer.

3. The sports computer application of claim 1 wherein the program creates a profile with a username and password.

4. The sports computer application of claim 1 wherein the program includes menu prompts allowing creation of a profile/portfolio.

5. The sports computer application of claim 4 wherein the profile/portfolio comprises a resume, at least one photo, at least one highlight video, medical reports, contact information, desired playing position, and left or right status.

6. The sports computer application of claim 5 wherein the profile/portfolio is viewable by predetermined sporting clubs.

7. The sports computer application of claim 6 wherein users are able to search the predetermined sporting clubs.

8. The spots computer application of claim 6 wherein the predetermined sporting clubs are able to advertise for needed players.

9. The sports computer application of claim 1 wherein the software program covers a sport selected from the group consisting of soccer, basketball, and (American) football.

10. The sports computer application of claim 1 wherein the software program provides instant, direct contact between athletes and the predetermined sporting clubs.

11. The sports computer application of claim 1 wherein the software program is available in a digital download store, for a nominal fee, and compatible with iPhones, iPads, and other smartphone and tablet computer platforms.

12. The sports computer application of claim 1 wherein the software program can sync with Google Calendar, iCloud, and Exchange.

13. A method for connecting athletes and other users with desired sports clubs and organizations, the method comprising:
providing an electronic device;
downloading a software program on the electronic device;
launching the software program:
allowing the athlete to download data into the electronic device; and
relating the downloaded data specifically to sports data and statistics.

14. A sports computer application for connecting athletes and other users with desired sports clubs and organizations, the sports computer application comprising:
an electronic device; and
a software program downloaded on the electronic device;
wherein upon launching the software program, the software program allows the athlete to download data into the electronic device, the downloaded data related to sports data and statistics;
wherein the software program creates a profile with a username and password; and
wherein the software program includes menu prompts allowing creation of a profile/portfolio.

15. The sports computer application of claim 14 wherein the profile/portfolio comprises a resume, at least one photo, at least one highlight video, medical reports, contact information, desired playing position, and left or right status.

16. The sports computer application of claim 15 wherein the profile/portfolio is viewable by predetermined sporting clubs.

17. The sports computer application of claim 16 wherein users are able to search the predetermined sporting clubs.

18. The spots con computer application of claim 16 wherein the predetermined sporting clubs are able to advertise for needed players.

19. The sports computer application of claim 14 wherein the software program provides instant, direct contact between athletes and the predetermined sporting clubs.

20. The sports computer application of claim 14 wherein the software program is available in a digital download store, for a nominal fee, and compatible with iPhones, iPads, and other smartphone and tablet computer platforms and wherein the software program can sync with Google Calendar, iCloud, and Exchange.
